(19) United States
(12) Patent Application Publication
(10) Pub. No.: US 2021/0354961 A1
(43) Pub. Date: Nov. 18, 2021

(54) Towable alignment lift

(71) Applicant: Jacob E. Kiragu, Seattle, WA (US)

(72) Inventor: Jacob E. Kiragu, Seattle, WA (US)

(21) Appl. No.: 16/865,338

(22) Filed: May 12, 2020

(51) Int. Cl. B66F 5/00

(52) U.S. Cl. CPC B66F 5/00

(57) ABSTRACT

The addition of axle less wheels to an alignment lift thereby forming a singular towable embodiment capable of travel on highways and performing multiple services efficiently outside the confines of a fixed repair facility. The axle less aspect of the improvement affords the ability to tow the embodiment and when raised offers a hollowed-out space clearance FIG. 3/3 previously not possible due to axles and cross member frames limitations. It becomes possible to, remove and install heavy undercarriage components that require varying types of jacking under the vehicle. FIG. 1/1 and FIG. 3/3. An alignment is required when components are replaced or disturbed. An improvement is apparent where addition of axle less wheels, FIG. 1 item 2 the detachable tow hitch coupler frame FIG. 2/2 or 3/3 items 3 to the alignment lift FIG. 1 item 1 thereby transforming it into a singular towable embodiment capable of raising and hauling.

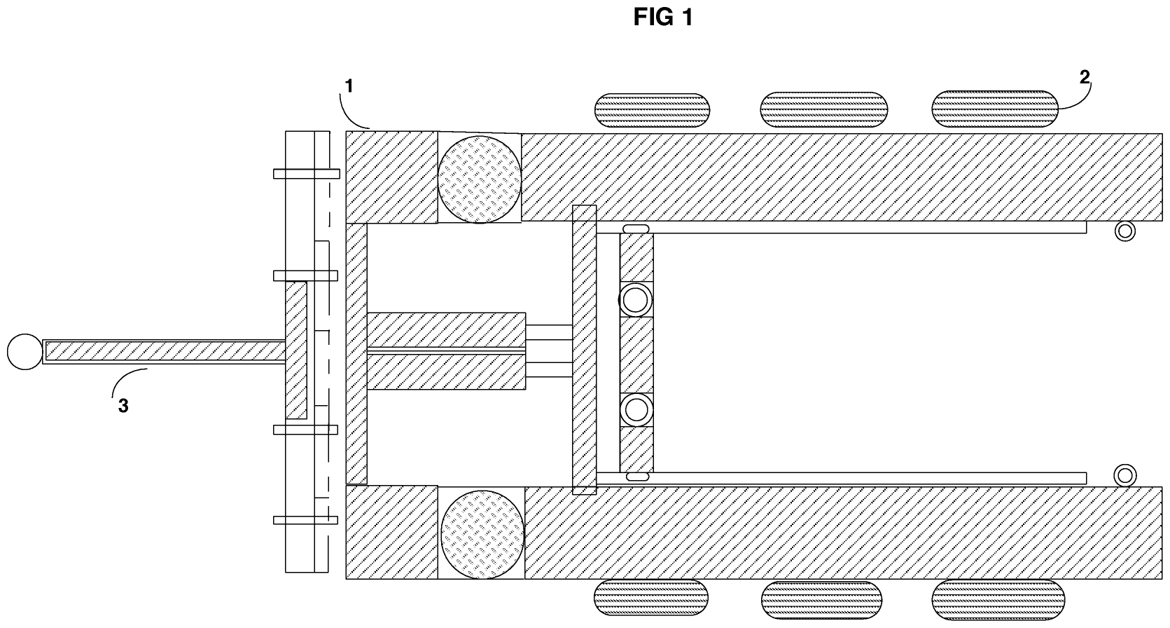

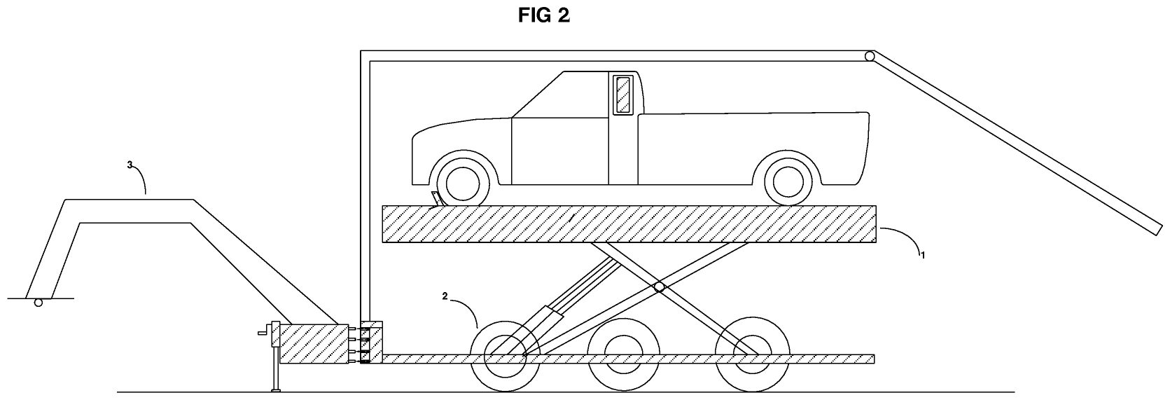

Addition of axle less wheels to the alignment scissor lift resulting in new use for the alignment lift as a singular towable embodiment capable of lifting or hauling without the need to merge with a trailer. The addition gives the alignment lift the capability to become towable on roadways/highways therefore operable outside the confines of a fixed repair facility. This is made possible by the detachable tow hitch coupler framework that is mountable on the front section of the alignment lift. The addition of the axle less wheels and detachable hitch coupler broadens the scope of use and_services of the alignment lift. It becomes a towable tool capable of travel on highways. The towable function allows the ability to broaden scope of services previously offered only in fixed repair facilities. An improvement is apparent where addition of axle less wheels FIG. 1 item 2, the detachable tow hitch coupler frame FIG. 2/2 or 3/3 items 3 to the alignment lift FIG. 1 item 1 thereby transforming it into a singular towable embodiment capable of raising, hauling and performing alignments after heavy undercarriage components have been repaired, replaced or disturbed.

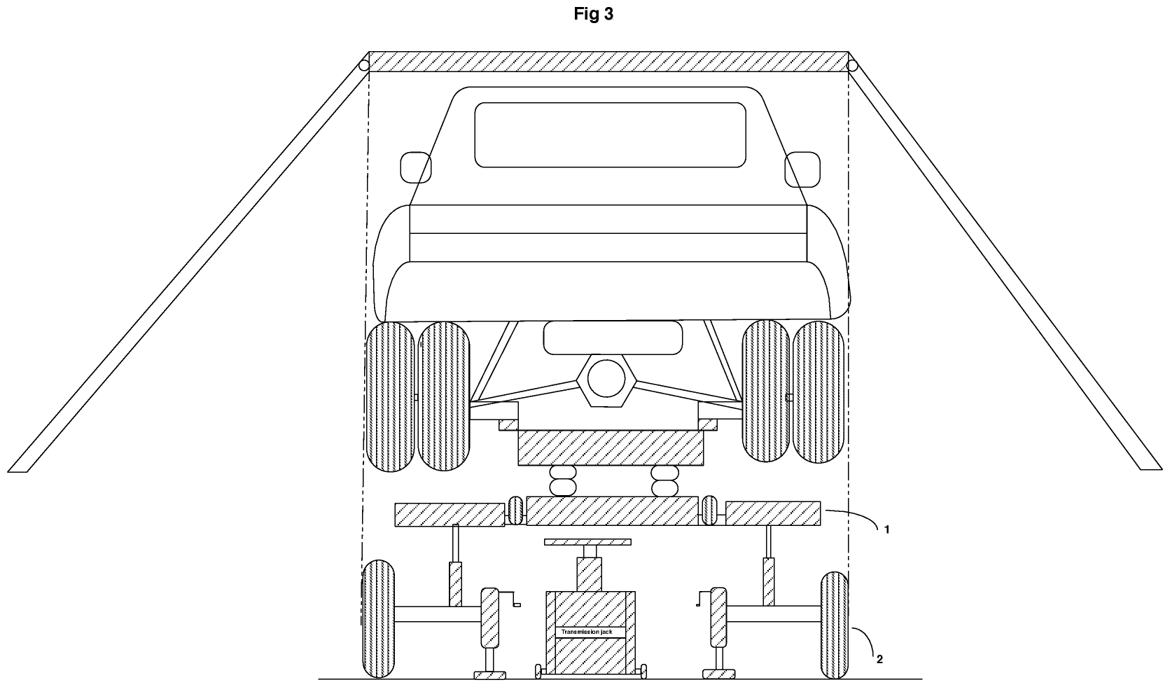

Drawing descriptions FIG. 1/3 is the top view showing item 1 as the axle less wheel system and item 2 as the alignment lift. The top view demonstrates the space clearance created by using the axle less wheel on the alignment lift leaving a clear space in the central area for the movement of the transmission jacks and rolling jacks without interference from metallic cross members. FIG. 2/3 is the side view showing the utility of the alignment lift in its elevated position as a towable embodiment that can be utilized as a trailer. The axle less wheels mounted on to the alignment lift transform it into a towable embodiment that does not require mounting on to a trailer but also allows for the lift to function as originally intended only now it is capable of mobility as a towed embodiment. FIG. 3/3 shows the rear view of the embodiment in its elevated state demonstrating the attachment of the axles wheels item 2 to the alignment lift item 1 clearly allowing space for a transmission jack to roll in and out from the rear and also showing the function of the rolling jacks.

What is claimed is:

1. The right to add axle less wheels FIG. 1/1 item (2) to the alignment lift frame by attaching the wheels to the alignment lift base frame, item (1): A synergy is created when the axle less wheels are added & the lift becomes a towable singular embodiment capable of raising, hauling & performing alignments without the need to mount on a trailer, FIG. 1/1 items (1&2).
The addition improves the alignment lift making it capable of towage, travel & transport on highways or roadways not previously anticipated by its inventors thus allowing for performance of services previously reserved for fixed repair facilities. Note: Some full-length alignment lifts do not have the rotating turn tables but are alignment lifts, nonetheless.
